(19) United States
(12) Patent Application Publication
(10) Pub. No.: US 2025/0084262 A1
(43) Pub. Date: Mar. 13, 2025

(54) METHOD FOR PRODUCING AQUEOUS DISPERSION, AQUEOUS DISPERSION, AND AQUEOUS INK

(71) Applicant: RISO KAGAKU CORPORATION, Tokyo (JP)

(72) Inventors: Seigou KAWAGUCHI, Yamagata (JP); Yoshifumi WATANABE, Tokyo (JP); Shinsuke OZAWA, Tokyo (JP); Hideki IMANISHI, Tokyo (JP)

(21) Appl. No.: 18/830,045

(22) Filed: Sep. 10, 2024

(30) Foreign Application Priority Data
Sep. 12, 2023 (JP) 2023-147789

(51) Int. Cl. C09D 7/80; C09D 11/322

(52) U.S. Cl. CPC C09D 7/80; C09D 11/322

(57) ABSTRACT

A method for producing an aqueous dispersion is disclosed, the method including: obtaining an aqueous titanium oxide dispersion containing titanium oxide particles, a dispersant, and water; and obtaining titanium oxide composite particles by adding a polymerizable monomer and a polymerization initiator to the aqueous titanium oxide dispersion to polymerize the polymerizable monomer, in which the obtaining of the titanium oxide composite particles includes adding the polymerizable monomer at a mass ratio of 1/5 or more relative to the total amount of the titanium oxide particle at one time, and the polymerizable monomer contains a polymerizable monomer A of which solubility in water is 0.5 g/100 ml or less at 23° C. An aqueous dispersion and an aqueous ink are also disclosed.

### CROSS REFERENCE TO RELATED APPLICATIONS

This application is based upon and claims the benefit of priority from the prior Japanese Patent Application No. 2023-147789, filed on Sep. 12, 2023, the entire contents of which are incorporated by reference herein.

### TECHNICAL FIELD

Embodiments of the present invention relate to a method for producing an aqueous dispersion, an aqueous dispersion, and an aqueous ink.

### BACKGROUND

Examples of methods for forming images such as text, pictures, or designs onto recording media such as films, cardboards, and fabrics include screen printing and gravure printing, but inkjet printing performed in a substantially plateless manner is recently attracting considerable attention.

When printing on a recording medium that is not white, such as a dark recording medium or a transparent recording medium, it is sometimes necessary to conceal a base in order to improve the color development of a printed matter, for example. It is common to use a white ink having concealment properties to conceal the base, and an inorganic pigment having high concealment properties, especially titanium oxide, is often used as a pigment in such a white ink.

JP 2021-105087 A discloses that an aqueous white dispersion in which titanium oxide is dispersed with a dispersant has temporal dispersion stability capable of suppressing precipitation of pigment particles, and that a white ink layer with good whiteness can be formed.

JP 2019-73595 A discloses a method for producing an aqueous dispersion of fine white particles: including a step of obtaining a dispersion liquid of fine particles by mixing fine white particles (titanium oxide) with a polymer dispersant in an aqueous medium; and a step of adding a polymerizable monomer to the obtained dispersion liquid of fine particles for polymerization and obtaining an aqueous dispersion of fine white particles. JP 2019-73595 A further discloses that an aqueous ink can be obtained which can achieve both ink jetting stability and gloss of the obtained printed matter by using the aqueous dispersion of fine white particles.

### SUMMARY

An embodiment of the present invention provides a method for producing an aqueous dispersion, the method including: obtaining an aqueous titanium oxide dispersion containing titanium oxide particles, a dispersant, and water; and obtaining titanium oxide composite particles by adding a polymerizable monomer and a polymerization initiator to the aqueous titanium oxide dispersion to polymerize the polymerizable monomer, in which the obtaining of the titanium oxide composite particles includes adding the polymerizable monomer at a mass ratio of 1/5 or more relative to the total amount of the titanium oxide particles at one time, and the polymerizable monomer contains a polymerizable monomer A of which solubility in water is 0.5 g/100 ml or less at 23° C.

Another embodiment of the present invention provides an aqueous dispersion including: raspberry-like titanium oxide composite particles containing titanium oxide particles and a resin covering surfaces of the titanium oxide particles; and water.

Another embodiment of the present invention provides an aqueous ink including: raspberry-like titanium oxide composite particles containing titanium oxide particles and a resin covering surfaces of the titanium oxide particles; and water.

### BRIEF DESCRIPTION OF DRAWINGS

FIG. 1A is an electron micrograph of an example of raspberry-like titanium oxide composite particles.

FIG. 1B is an electron micrograph of an example of raspberry-like titanium oxide composite particles.

FIG. 2A is an electron micrograph of an example of non-raspberry-like titanium oxide composite particles.

FIG. 2B is an electron micrograph of an example of non-raspberry-like titanium oxide composite particles.

FIG. 3A is an electron micrograph of an example of titanium oxide particles when titanium oxide is dispersed with a dispersant.

FIG. 3B is an electron micrograph of an example of titanium oxide particles when titanium oxide is dispersed with a dispersant.

### DETAILED DESCRIPTION OF EMBODIMENTS

The present invention will be described below using embodiments. The examples in the following embodiments in no way limit the present invention. In the following description, an “aqueous ink” may be simply referred to as an “ink”.

### <Method for Producing Aqueous Dispersion>

A method for producing an aqueous dispersion according to some embodiments includes obtaining an aqueous titanium oxide dispersion containing titanium oxide particles, a dispersant, and water (hereinafter also referred to as “step 1”) and obtaining titanium oxide composite particles by adding a polymerizable monomer and a polymerization initiator to the aqueous titanium oxide dispersion to polymerize the polymerizable monomer (hereinafter also referred to as “step 2”), in which step 2 includes adding the polymerizable monomer at a mass ratio of 1/5 or more relative to the total amount of the titanium oxide particles at one time, and the polymerizable monomer contains a polymerizable monomer A of which solubility in water is 0.5 g/100 ml or less at 23° C.

The aqueous dispersion obtained by the method for producing an aqueous dispersion of some embodiments can be used for obtaining an aqueous ink having a high degree of whiteness. The reasons thereof are thought to include the following, but the scope of the present invention is not constrained by the following theory.

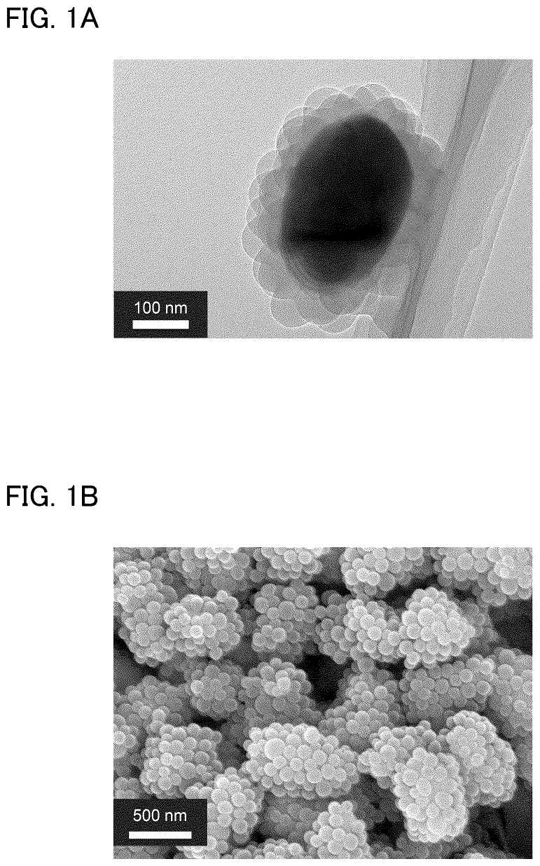

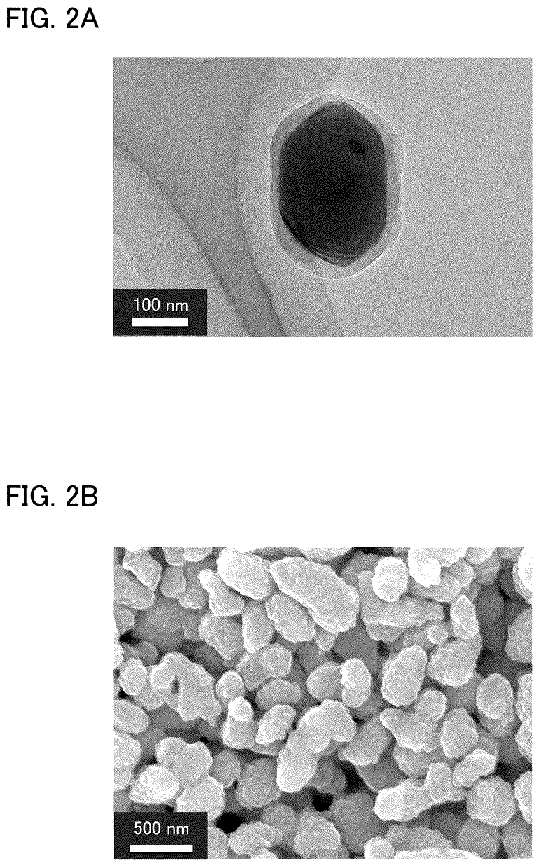

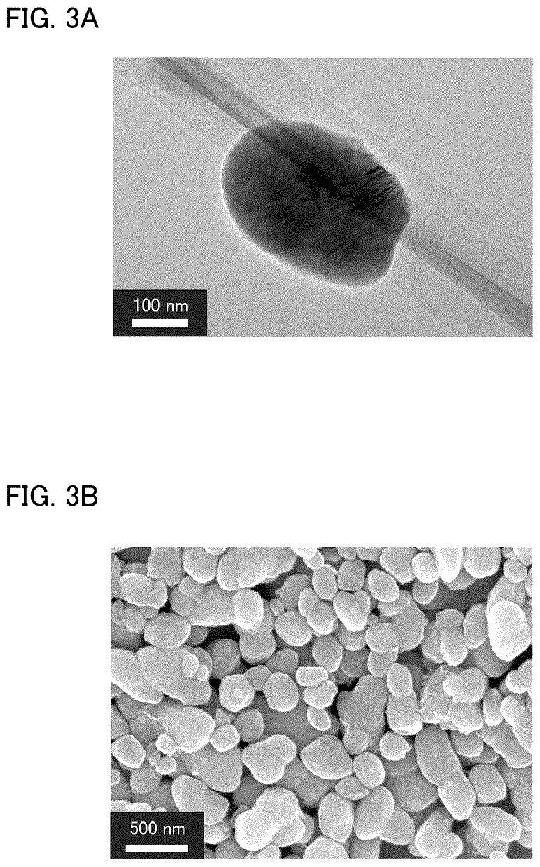

In the method for producing an aqueous dispersion of the embodiments, in step 2 of the obtaining titanium oxide composite particles by adding a polymerizable monomer and a polymerization initiator to the aqueous titanium oxide dispersion to polymrize the polymerizable monomer, the polymerizable monomer used contains a polymerizable monomer A of which solubility in water is 0.5 g/100 ml or less at 23° C. Further, step 2 includes a step of adding the polymerizable monomer at a mass ratio of 1/5 or more relative to the total amount of the titanium oxide particles in the aqueous titanium oxide dispersion. Here, the amount of the polymerizable monomer containing the polymerizable monomer A, of which solubility in water is low, may be relatively abundant relative to the surface area of the titanium oxide particles, and, therefore, resin particles may be easily formed by means of polymerization of the polymerizable monomer. It is inferred that such resin particles may gather on surfaces of the titanium oxide particles to form a raspberry-like shape, thereby forming raspberry-like titanium oxide composite particles. It is also inferred that due to an increase in the surface area by the raspberry-like particle shape, the reflectance of visible light may be enhanced, and the whiteness may be enhanced. Each of FIGS. 1A and 1B shows an electron micrograph of an example of raspberry-like titanium oxide composite particles. For comparison, each of FIGS. 2A and 2B shows an electron micrograph of an example of non-raspberry-like titanium oxide composite particles. For further comparison, each of FIGS. 3A and 3B shows an electron micrographs of an example of titanium oxide particles in a case where titanium oxide particles are dispersed with a dispersant.

Since an inorganic pigment such as a titanium oxide has a high specific gravity, when such a pigment is used for an ink with relatively low viscosity, such as an inkjet ink, suppression of pigment precipitation may be an issue. When a particle diameter of the titanium oxide is reduced to suppress pigment precipitation, white color development properties tend to decrease. If the method for producing an aqueous dispersion of embodiments is used, pigment precipitation can also be suppressed. The reason thereof is presumed to be that the density of the titanium oxide composite particles is lower than that of particles of titanium oxide alone, and particle precipitation may be easily suppressed. When pigment particles precipitate, a cake layer may be formed due to the precipitated particles, and redispersibility may be reduced. However, in the aqueous dispersion produced by the producing method of embodiments, formation of the cake due to the precipitated particles may also be suppressed, and redispersibility tends to be excellent.

Step 1 of obtaining an aqueous titanium oxide dispersion containing titanium oxide particles, a dispersant, and water will be described.

The titanium oxide particles are not particularly limited.

Examples of crystal structures of titanium oxide include a rutile type (tetragonal), anatase type (tetragonal), and brookite type (orthorhombic), but a rutile type titanium oxide is preferable from the viewpoint of crystal stability, concealment properties, and availability.

Untreated titanium oxide particles may be used, but from the viewpoint of obtaining good dispersibility, it is preferable that surfaces thereof are treated. Examples of surface treatment of titanium oxide particles include surface treatment with inorganic substances and surface treatment with organic substances such as titanium coupling agents, silane coupling agents, or silicone oil. Surface treatment with inorganic substances is preferable.

Examples of a surface treatment method of titanium oxide particles with an inorganic substance include a treatment method using one or more substances selected from alumina (Al₂O₃), silica (SiO₂), zinc oxide (ZnO), zirconia (ZrO₂), magnesium oxide (MgO), and the like.

Since titanium oxide particles have organic degradability due to photocatalytic activity, it is preferable to treat surfaces of titanium oxide particles with alumina, or the like, from the viewpoint of suppressing photocatalytic activity and enhancing titanium oxide wetting during dispersion. In addition, from the viewpoint of adjusting acid/base states and enhancing weather resistance of titanium oxide particle surfaces, it is also possible to use silica for surface treatment. From the viewpoint of the strength of a surface treatment layer, alumina is more preferable than silica because alumina has larger strength.

From the above viewpoint, titanium oxide particles are more preferably treated with at least one or more substances selected from alumina, silica, zinc oxide and zirconia, and even more preferably treated with at least one or more substances selected from alumina and silica. It is particularly preferable to treat with at least alumina. The titanium oxide particles may be titanium oxide particles of which surfaces are treated with alumina, or titanium oxide particles of which surfaces are treated with silica and alumina, for example.

The primary particle diameter of the titanium oxide particles is preferably 150 nm or more, 180 nm or more, 200 nm or more, or 250 nm or more. The primary particle diameter of the titanium oxide particles is preferably 400 nm or less, 350 nm or less, 300 nm or less, or 280 nm or less. The primary particle diameter of the titanium oxide particles may be in a range from 150 to 400 nm, in a range from 150 to 350 nm, in a range from 180 to 300 nm, in a range from 200 to 300 nm, or in a range from 250 to 280 nm, for example.

The primary particle diameter of the titanium oxide particles is an arithmetic mean particle diameter in terms of the number of particles obtained from an electron microscope image. Specifically, the diameter is calculated using a major diameter of each particle. The same applies to the primary particle diameter of titanium oxide particles in the following description.

The dispersant is not particularly limited. Examples thereof include a polymeric dispersant, and a surfactant-type dispersant.

From the viewpoint of dispersion stability, a polymeric dispersant is preferable as the dispersant. The weight average molecular weight of the polymeric dispersant is preferably 3,000 or more, and more preferably 5,000 or more. The weight average molecular weight of the polymeric dispersant is preferably in a range from 3,000 to 50,000 and more preferably in a range from 5,000 to 30,000, for example. In the present disclosure, the weight average molecular weight is obtained as a polystyrene-equivalent value using gel permeation chromatography (GPC) analysis.

From the viewpoint of forming raspberry-like titanium oxide composite particles, a dispersant having an acidic group is preferable. It is speculated that when using a dispersant having an acidic group, surfaces of the titanium oxide particles can be easily made anionic, and for example, when the resin particles are cationic, raspberry-like titanium oxide composite particles can be easily obtained by adsorbing them to the anionic titanium oxide particles. A polymeric dispersant having an acidic group is preferable as a dispersant having an acidic group.

Examples of the acidic group include a carboxyl group, a sulfo group, a phosphate group, and the like.

Examples of a polymeric dispersant having an acidic group include an isobutylene-maleic acid copolymer, an aromatic sulfonic acid formalin condensate, a polycarboxylic acid-based polymer, and salts thereof. Examples of a commercially available isobutylene-maleic acid copolymer product include “ISOBAN-600” manufactured by Kuraray Co., Ltd. A sodium salt of “ISOBAN-600” may be used as a polymeric dispersant having an acidic group, for example. Examples of a commercially available sodium salt of an aromatic sulfonic acid formalin condensate product is “DEMOL N” manufactured by Kao Corporation. Examples of a commercially available polycarboxylic acid-based polymer product and a salt thereof include “DEMOL EP” manufactured by Kao Corporation.

In the aqueous titanium oxide dispersion obtained in step 1, the amount of the dispersant relative to the amount of the titanium oxide particles is preferably in a range from 0.01 to 2.0% by mass, and more preferably in a range from 0.1 to 1.0% by mass.

There are no particular limitations placed on water used, but it is preferable to use water containing minimal ionic components. Examples of water include purified water, ion-exchanged water, distilled water, and ultra-pure water.

The aqueous titanium oxide dispersion obtained in step 1 may contain other components. Examples of other components include pH adjusters and preservatives.

There are no particular limitations on the method for obtaining the aqueous titanium oxide dispersion containing titanium oxide particles, a dispersant, and water in step 1, and production may be performed using appropriate conventional methods, for example. The dispersion can be obtained by using a stirring device to disperse all of the components, either in a single batch, or in multiple separate batches, for example. Thereafter, water or the like may be further added thereto, for example.

The average particle diameter (dispersion particle diameter) of the titanium oxide particles in the aqueous titanium oxide dispersion is preferably in a range from 200 to 500 nm, and more preferably in a range from 250 to 450 nm.

The average particle diameter (dispersion particle diameter) of the titanium oxide particles in the aqueous titanium oxide dispersion refers to the volume-based average particle diameter measured by means of a dynamic light scattering method (DLS). The same applies to the average particle diameter (dispersion particle diameter) of titanium oxide particles in an aqueous titanium oxide dispersion in the following description.

A description will be given below regarding step 2 of obtaining titanium oxide composite particles by adding a polymerizable monomer and a polymerization initiator to the aqueous titanium oxide dispersion to polymerize the polymerizable monomer.

In step 2, a single polymerizable monomer can be used, or a combination of two or more polymerizable monomers can be used.

Monomers having a polymerizable group can be used as the polymerizable monomer. Examples of the polymerizable group include a vinyl group, an allyl group, an isopropenyl group, and a (meth)acryloyl group. Examples of the polymerizable monomer include a (meth)acrylate monomer, an aromatic group-containing monomer, and a heterocycle-containing monomer. (Meth)acryloyl group means an acryloyl group, a methacryloyl group, or both. (Meth)acrylate means a methacrylate, an acrylate, or both.

Examples of the (meth)acrylate monomer include a (meth)acrylate which contains an alkyl group having 1 to 12 carbon atoms; an alicyclic (meth)acrylate having a group having an alicyclic structure; and an aromatic group-containing (meth)acrylate which is also listed as an example of an aromatic group-containing monomer that will be described later. Examples of the alkyl group having 1 to 12 carbon atoms include ethyl, propyl, butyl, 2-ethylhexyl, and dodecyl. Examples of the alicyclic alkyl group include isobornyl and cyclohexyl.

Examples of the aromatic group-containing monomer include a styrene-based monomer and an aromatic group-containing (meth)acrylate. Examples of the styrene-based monomer include styrene, 2-methylstyrene, α-methylstyrene, and vinyl toluene. Examples of the aromatic group-containing (meth)acrylate include phenyl (meth)acrylate, benzyl (meth)acrylate, phenoxyethyl (meth)acrylate, 1-naphthyl (meth)acrylate, and ethoxylated-o-phenylphenol acrylate.

Examples of the heterocycle-containing monomer include vinylpyridine, vinylcarbazole, and vinylpyrrolidone.

In step 2, a single polymerizable monomer can be used, or a combination of two or more polymerizable monomers can be used.

The amount of polymerizable monomer used is preferably in a range from 0.2 to 10, more preferably in a range from 0.3 to 2, and even more preferably in a range from 0.5 to 1.5, expressed as a mass ratio relative to a value of 1 for the titanium oxide particles.

From the viewpoint of forming the raspberry-like titanium oxide composite particles, in step 2 it is preferable to use the polymerizable monomer A of which solubility in water is 0.5 g/100 ml or less at 23° C. The solubility of the polymerizable monomer A in water is preferably 0.5 g/100 ml or less at 23° C., and more preferably 0.3 g/100 ml or less at 23° C. It is even more preferable that the monomer is substantially insoluble in water.

Examples of the polymerizable monomer A include styrene, benzyl (meth)acrylate, butyl (meth)acrylate, and vinylcarbazole.

From the viewpoint of further enhancing the whiteness of an aqueous ink, a polymerizable monomer capable of obtaining a resin having a high refractive index such as polystyrene is preferable as the polymerizable monomer. Examples of this kind of polymerizable monomer include styrene, benzyl (meth)acrylate, and vinylcarbazole described above.

From the viewpoint of further enhancing the redispersibility, it is preferable to use a polymerizable monomer capable of obtaining a resin having a low specific gravity, a high glass transition temperature (Tg), and hydrophobicity. From this viewpoint, styrene, benzyl (meth)acrylate, and vinylcarbazole are preferable.

A single polymerizable monomer A can be used, or a combination of two or more polymerizable monomers A can be used.

The total amount of the polymerizable monomer used in step 2 may be, for example, the polymerizable monomer A, or may be, for example, a combination of the polymerizable monomer A and a polymerizable monomer other than the polymerizable monomer A. The amount of the polymerizable monomer A relative to the total amount of the polymerizable monomer is preferably 30% by mass or more, more preferably 50% by mass or more, and even more preferably 70% by mass or more. The amount of the polymerizable monomer A relative to the total amount of the polymerizable monomer may be 100% by mass or less, for example. The amount of the polymerizable monomer A relative to the total amount of the polymerizable monomer may be in a range from 30 to 100% by mass, in a range from 50 to 100% by mass, or in a range from 70 to 100% by mass.

As the polymerization initiator, a polymerization initiator generally used for emulsion polymerization can be used, but it is preferable to use a water-soluble polymerization initiator.

Specific examples of the polymerization initiator include a persulfate salt, an organic peroxide, and an azo-based polymerization initiator. Examples of the persulfate salt include potassium persulfate and ammonium persulfate. Examples of the organic peroxide include hydrogen peroxide and t-butyl hydroperoxide. Examples of the azo-based polymerization initiator include 4,4′-azobis(4-cyanovaleric acid), 2,2-azobis(2-amidinopropane) dihydrochloride, and 2,2′-azobis [N-(2-carboxyethyl)-2-methylpropionamidine] 4 hydrate. As the polymerization initiator, it is possible to use a redox initiator a polymerization initiator described above and a reducing agent are combined. Examples of the reducing agent include sodium sulfoxylate formaldehyde, ascorbic acid, sulfite, tartaric acid, and salts thereof.

From the viewpoint of forming the raspberry-like titanium oxide composite particles, the polymerization initiator is preferably an anionic polymerization initiator, a nonionic polymerization initiator, or a polymerization initiator having a zwitterionic structure, and it is more preferable to use the polymerization initiator having a zwitterionic structure. When a polymerization initiator having a zwitterionic structure is used, it is considered that amphoteric functional groups are introduced to the resulting resin particles, and these resin particles become cationic in acid to neutral environments and are easily adsorbed on an anionic surface. For this reason, when, for example, acidic groups derived from a dispersant or the like are present on the surfaces of the titanium oxide particles, it is assumed that the resin particles obtained by means of polymerization are easily adsorbed to the titanium oxide particles, and the raspberry-like composite particles are easily obtained.

A single polymerization initiator can be used or a combination of two or more polymerization initiators can be used.

The amount of polymerization initiator used relative to the amount of polymerizable monomer is preferably in a range from 0.01 to 10% by mass, more preferably in a range from 0.05 to 5% by mass, and even more preferably in a range from 0.1 to 2% by mass.

Step 2 can include a step (hereinafter referred to as step 2X) of adding a polymerizable monomer at a mass ratio of 1/5 or more relative to the total amount of titanium oxide particles at one time. In step 2X, the polymerizable monomer at a mass ratio of 1/5 or more relative to the total amount of titanium oxide particles is added into the aqueous titanium oxide dispersion at one time, instead of being divided and added in multiple batches or being added continuously, such as by dropwise continuous addition. The amount of polymerizable monomer to be added in step 2X may be the total amount of polymerizable monomer to be added in step 2, or may be a part thereof.

The amount of polymerizable monomer to be added in step 2X relative to the total amount of titanium oxide particles is preferably 1/5 or more, more preferably 1.5/5 or more, and even more preferably 2/5 or more, at a mass ratio. The amount of polymerizable monomer to be added in step 2X relative to the total amount of titanium oxide particles may be, for example, 10/5 or less, 5/5 or less, 4/5 or less, or 3/5 or less, at a mass ratio. The amount of polymerizable monomer to be added in step 2X relative to the total amount of titanium oxide particles may be, for example, in a range from 1/5 to 10/5, in a range from 1/5 to 5/5, in a range from 1.5/5 to 4/5, or in a range from 2/5 to 3/5, at a mass ratio.

It is thought that, in step 2, the raspberry-like titanium oxide composite particles can be obtained, and that when the raspberry-like titanium oxide composite particles are formed, an aqueous dispersion usable for obtaining an aqueous ink with a high degree of whiteness may be obtained.

It is also thought that, if step 2 does not include step 2X and the total amount of polymerizable monomer is, for example, continuously added dropwise, it is not possible to obtain the raspberry-like particles. It is assumed that this is because polymerization of the polymerizable monomer proceeds gradually, and a thin resin layer gradually grows on a surface of titanium oxide.

In step 2, a surfactant may be additionally added.

Surfactants are adsorbed on the surfaces of the titanium oxide particles, modify the particle surfaces, and can be used to suppress aggregation, to make the particle surfaces more hydrophobic, and to impart ionic properties to the particle surfaces, for example. Further, surfactants may be used as starting points for polymerization of the polymerizable monomer. Surfactants may be used to enhance the stability of polymerization. Examples of surfactants include anionic surfactants, nonionic surfactants, cationic surfactants, amphoteric surfactants, and polymeric surfactants. Anionic or nonionic surfactants are preferable.

Using a surfactant cloud point, by dissolving a surfactant at a temperature below the cloud point and then precipitating a surfactant on the particle surfaces at a temperature which is equal to or above the cloud point, the adsorption efficiency of the surfactant to the particles can be enhanced, for example.

From the viewpoint of polymerizing the polymerizable monomer with a surfactant as a starting point, it is preferable to use a surfactant having a polymerizable group, for example. Examples of the polymerizable group include a vinyl group, an allyl group, an isopropenyl group, and a (meth)acryloyl group.

Examples of anionic surfactants having a polymerizable group include bis(polyoxyethylene polycyclic phenyl ether) methacrylated sulfonate salt (for example, “ANTOX MS-60” manufactured by NIPPON NYUKAZAI CO., LTD.), propenyl-alkyl sulfosuccinate ester salt, (meth)acrylic polyoxyethylene sulfonate salt, (meth)acrylic polyoxyethylene phosphonate salt (for example, “ELEMINOL RS-30” manufactured by Sanyo Chemical Industries, Ltd.), polyoxyethylene alkyl propenyl phenyl ether sulfonate salt (for example, “AQUALON HS-10” manufactured by DKS Co. Ltd.), allyloxymethyl alkyloxy polyoxyethylene sulfonate salt (for example, “AQUALON KH-10” manufactured by DKS Co. Ltd.), allyloxymethyl nonyl phenoxyethyl hydroxypolyoxyethylene sulfonate salt (for example, “ADEKA REASOAP SE-10” manufactured by ADEKA CORPORATION), allyloxymethyl alkoxyethyl hydroxypolyoxyethylene sulfate salt (for example, “ADEKA REASOAP SR-10” and “ADEKA REASOAP SR-30” manufactured by ADEKA CORPORATION), and polyoxyethylene styrenated propenyl phenyl ether sulfate ammonium salt (for example, “AQUALON AR-10”, “AQUALON AR-20”, and “AQUALON AR-30” manufactured by DKS Co. Ltd.).

Examples of nonionic surfactants having a polymerizable group include allyloxymethylalkoxyethyl hydroxypolyoxyethylene (for example, “ADEKA REASOAP ER-20” manufactured by ADEKA CORPORATION), polyoxyethylene alkyl propenyl phenyl ether (for example, “AQUALON RN-20” manufactured by DKS Co. Ltd.), allyloxymethylnonylphenoxyethyl hydroxypolyoxyethylene (for example, “ADEKA REASOAP NE-10” manufactured by ADEKA CORPORATION), and polyoxyethylene styrenated propenyl phenyl ether (for example, “AQUALON AN-10”, “AQUALON AN-20”, “AQUALON AN-30”, and “AQUALON AN-5065” manufactured by DKS Co. Ltd.).

It is more preferable to use a non-nonylphenyl type surfactant, especially when environmental aspects are concerned.

Examples of anionic surfactants without a polymerizable group include alkyl sulfate salts such as ammonium dodecyl sulfate and sodium dodecyl sulfate; alkyl sulfonate salts such as ammonium dodecyl sulfonate and sodium dodecyl sulfonate; alkyl aryl sulfonate salts such as ammonium dodecyl benzene sulfonate and sodium dodecyl naphthalene sulfonate; polyoxyethylene alkyl sulfate salts; polyoxyethylene alkyl aryl sulfate salts; dialkyl sulfosuccinate salts; arylsulfonic acid formalin condensates; and fatty acid salts such as ammonium laurate and sodium stearate.

Examples of nonionic surfactants without a polymerizable group include polyoxyethylene alkyl ethers; polyoxyethylene alkyl aryl ethers; condensates of polyethylene glycol and polypropylene glycol; sorbitan fatty acid esters; polyoxyethylene sorbitan fatty acid esters; fatty acid monoglycerides; polyamides; and condensation products of ethylene oxide and aliphatic amines.

Examples of cationic surfactants without polymerizable groups include alkylammonium salts such as dodecylammonium chlorides.

Examples of amphoteric surfactants without a polymerizable group include betaine ester-type emulsifiers.

Examples of polymeric surfactants without a polymerizable group include poly(meth)acrylate salts such as sodium polyacrylate; polyvinyl alcohol; polyvinylpyrrolidone; polyhydroxyalkyl (meth)acrylates such as polyhydroxyethyl acrylate; and copolymers using one or more of polymerizable monomers used for forming these polymers as copolymerization components.

A single surfactant can be used or a combination of two or more surfactants can be used.

The amount of surfactant used relative to the amount of polymerizable monomer is preferably in a range from 0.01 to 10% by mass, more preferably in a range from 0.05 to 8% by mass, and even more preferably in a range from 0.1 to 5% by mass.

In step 2, a polymerizable monomer, a polymerization initiator, and, if necessary, a surfactant or the like can be added to the aqueous titanium oxide dispersion obtained in step 1 to polymerize the polymerizable monomer, for example.

Step 2 includes step 2X of adding the polymerizable monomer at a mass ratio of 1/5 or more relative to the total amount of titanium oxide particles at one time. The remainder of the polymerizable monomer may be added at one time, may be divided and added in multiple batches, or may be added continuously. Each of the polymerization initiator and, if necessary, the surfactant may be added at one time, may be divided and added in multiple batches, or may be added continuously.

In step 2, the total amount of the polymerizable monomer, the polymerization initiator, and, if necessary, the surfactant may be added at one time to perform a polymerization reaction, or they may be divided and added in two or more batches to perform a polymerization reaction in two or more stages, for example. In a first stage, a part of the polymerizable monomer, a part of the polymerization initiator, and, if necessary, a part of the surfactant may be added to the aqueous titanium oxide dispersion, or a dilution thereof, at one time to perform a polymerization reaction, and in a second stage the remainder of the polymerizable monomer, the remainder of the polymerization initiator, and, if necessary, the remainder of the surfactant may be added at one time, for example. In this case, in either the first stage or the second stage, the amount of polymerizable monomer to be added may be 1/5 or more relative to the total amount of titanium oxide particles at a mass ratio.

Polymerization conditions may be appropriately adjusted according to a monomer to be used, a polymerization initiator, and the like. The polymerization temperature is preferably in a range from 30 to 150° C., and more preferably in a range from 50 to 120° C., for example. The polymerization time is preferably in a range from 10 to 20 hours, and more preferably in a range from 1 to 10 hours, for example. When the polymerization is performed in two or more stages, the polymerization time of the first stage may be in a range from 10 minutes to 20 hours, or in a range from 1 hour to 10 hours.

After performing polymerization of the polymerizable monomer as described above, filtration, centrifugation, and the addition of water may be performed as necessary.

A resin is synthesized by polymerization of the polymerizable monomer as described above, and it is possible to obtain an aqueous dispersion of titanium oxide composite particles containing titanium oxide particles and the resin.

In the titanium oxide composite particles, the resin synthesized by means of polymerization of the polymerizable monomer may be a homopolymer of a polymerizable monomer A, a copolymer of two or more polymerizable monomers A, or a copolymer of one or more polymerizable monomers A and one or more other polymerizable monomers, for example.

In the titanium oxide composite particles, the resin obtained by means of polymerization of the polymerizable monomer preferably covers surfaces of the titanium oxide particles. The resin may cover at least a portion of the surfaces of the titanium oxide particles. The resin may cover only a portion of the surfaces of the titanium oxide particles or the entire surfaces of the titanium oxide particles. The resin in the titanium oxide composite particles preferably has the shape of resin particles. The titanium oxide composite particles are preferably raspberry-like titanium oxide composite particles containing titanium oxide particles and a resin covering surfaces of the titanium oxide particles.

The average particle diameter of the titanium oxide particles in the titanium oxide composite particles may be in a range from 150 to 400 nm, in a range from 150 to 350 nm, in a range from 180 to 300 nm, in a range from 200 to 300 nm, or in a range from 250 to 280 nm, for example. The resin in the titanium oxide composite particles preferably has a shape of resin particles with an average particle diameter of 10 to 200 nm, more preferably 50 to 180 nm.

Each of the average particle diameter of the titanium oxide particles in the titanium oxide composite particles and the average particle diameter of the resin particles in the titanium oxide composite particles is an arithmetic average diameter in terms of the number of particles obtained from an electron microscope image. Specifically, calculation is made using a diameter of a circle (circle equivalent diameter) of which area is the same as the projected area of the particle image. Hereinafter, the same applies to the average particle diameter of the titanium oxide particles in the titanium oxide composite particles, and the average particle diameter of the resin particles in the titanium oxide composite particles.

In the aqueous dispersion obtained in this manner, the amount of titanium oxide particles relative to the total amount of aqueous dispersion is preferably in a range from 1 to 50% by mass, more preferably in a range from 10 to 40% by mass, and even more preferably in a range from 20 to 30% by mass.

In the aqueous dispersion, the amount of titanium oxide composite particles, as the total amount of the titanium oxide particles and the polymerizable monomer for forming the titanium oxide composite particles, relative to the total amount of aqueous dispersion, is preferably in a range from 20 to 80% by mass, more preferably in a range from 30 to 70% by mass, and even more preferably in a range from 40 to 60% by mass.

In the method for producing the aqueous dispersion, other components may also be used. Examples of other components include pH adjusters, preservatives, rust inhibitors, and anti-foaming agents.

The viscosity of the aqueous dispersion obtained by the above method is preferably in a range from 1 to 20 mPa·s at 23° C.

The average particle diameter (dispersion particle diameter) of the titanium oxide composite particles in the aqueous dispersion obtained by the above method is preferably in a range from 300 to 600 nm and more preferably in a range from 350 to 550 nm.

The average particle diameter (dispersion particle diameter) of the titanium oxide composite particles in the aqueous dispersion refers to a volume-based average particle diameter measured using a dynamic light scattering method (DLS). Hereinafter, the same applies to the average particle diameter (dispersion particle diameter) of the titanium oxide composite particles in the aqueous dispersion.

### <Aqueous Dispersion>

The aqueous dispersion according to one embodiment contains water and the raspberry-like titanium oxide composite particles containing titanium oxide particles and a resin covering surfaces of the titanium oxide particles.

The aqueous dispersion can be used to obtain an ink having a high degree of whiteness. In the aqueous dispersion, the pigment precipitation may be suppressed, and the redispersibility may be excellent.

The titanium oxide particles described for the above method for producing an aqueous dispersion can be used as the titanium oxide particles in the titanium oxide composite particles, for example.

The resin in the titanium oxide composite particles may be obtained by polymerizing one or more of the polymerizable monomers which may be used in step 2 of the above method for producing an aqueous dispersion, for example. The resin preferably contain one or more units each derived from one or more of the polymerizable monomers described above.

The resin in the titanium oxide composite particles preferably contains a unit derived from the polymerizable monomer A described above (the unit derived from a polymerizable monomer A may also be referred to as “polymerizable monomer A-derived unit). The resin may contain one or more types of polymerizable monomer A-derived units. The amount of the polymerizable monomer A-derived unit, expressed as the amount of the polymerizable monomer A relative to the total amount of polymerizable monomer used for forming the resin, is preferably 30% by mass or more, more preferably 50% by mass or more, and even more preferably 70% by mass or more. The amount of the polymerizable monomer A-derived unit, expressed as the amount of polymerizable monomer A relative to the total amount of polymerizable monomer used for forming the resin, may be 100% by mass or less, for example. The amount of the polymerizable monomer A-derived unit, expressed as the amount of polymerizable monomer A relative to the total amount of polymerizable monomer used for forming the resin, may be in a range from 30 to 100% by mass, in a range from 50 to 100% by mass, or in a range from 70 to 100% by mass.

The resin in the titanium oxide composite particles may be a homopolymer of a polymerizable monomer A, a copolymer of two or more polymerizable monomers A, or a copolymer of one or more polymerizable monomers A and one or more other polymerizable monomers, for example.

In the titanium oxide composite particles, the resin may cover at least a portion of the surfaces of the titanium oxide particles. The resin may cover only a portion of the surfaces of the titanium oxide particles, or the entire surfaces of the titanium oxide particles. The resin in the titanium oxide composite particles preferably has a shape of resin particles.

The average particle diameter of the titanium oxide particles in the titanium oxide composite particles may be in a range from 150 to 400 nm, in a range from 150 to 350 nm, in a range from 180 to 300 nm, in a range from 200 to 300 nm, or in a range from 250 to 280 nm, for example. The resin in the titanium oxide composite particles preferably has a shape of resin particles with an average particle diameter of 10 to 200 nm, more preferably, 50 to 180 nm.

The amount of resin in the titanium oxide composite particles is preferably in a range from 0.2 to 10, more preferably in a range from 0.3 to 2, and even more preferably in a range from 0.5 to 1.5, expressed as a mass ratio of the total amount of monomer used for forming the resin relative to a value of 1 for the titanium oxide particles.

In the aqueous dispersion, the amount of titanium oxide particles relative to the total amount of aqueous dispersion, is preferably in a range from 1 to 50% by mass, more preferably in a range from 10 to 40% by mass, and even more preferably in a range from 20 to 30% by mass.

In the aqueous dispersion, the amount of titanium oxide composite particles, as the total amount of the titanium oxide particles and the monomer used for forming the resin, relative to the total amount of aqueous dispersion is preferably in a range from 20 to 80% by mass, more preferably in a range from 30 to 70% by mass, and even more preferably in a range from 40 to 60% by mass.

There are no particular limitations placed on water used, but it is preferable to use water containing minimal ionic components. Examples of water include purified water, ion-exchanged water, distilled water, and ultra-pure water.

The aqueous dispersion may further contain other components, such as those described for the above method for producing an aqueous dispersion.

The aqueous dispersion can be produced by the above method for producing an aqueous dispersion, for example.

It is preferable that the viscosity of the aqueous dispersion is in a range from 1 to 20 mPa·s at 23° C.

The average particle diameter (dispersion particle diameter) of the titanium oxide composite particles in the aqueous dispersion is preferably in a range from 300 to 600 nm, and more preferably in a range from 350 to 550 nm.

### <Aqueous Ink>

An aqueous ink according to one embodiment contains water and raspberry-like titanium oxide composite particles that contain titanium oxide particles and a resin covering surfaces of the titanium oxide particles.

The ink can be used as a white ink, for example.

As the titanium oxide particles, the resin covering surfaces of the titanium oxide particles, and the titanium oxide composite particles, those described above for the aqueous dispersion may be used.

The amount of titanium oxide in the aqueous ink, relative to the total amount of ink, is preferably in a range from 0.1 to 30% by mass, more preferably in a range from 1 to 20% by mass, and even more preferably in a range from 1 to 15% by mass.

The amount of titanium oxide composite particles in the aqueous ink, as the total amount of the titanium oxide particles and the monomers used for forming the resin, relative to the total amount of ink is preferably in a range from 2 to 50% by mass, more preferably in a range from 5 to 40% by mass, and even more preferably in a range from 5 to 30% by mass.

There are no particular limitations placed on water used, but it is preferable to use water containing minimal ionic components. Examples of water include purified water, ion-exchanged water, distilled water, and ultra-pure water.

The amount of water in the aqueous ink, relative to the total amount of ink, is preferably in a range from 40 to 90% by mass, and more preferably in a range from 50 to 80% by mass.

It is preferable to blend a water-dispersible resin in the aqueous ink.

The water-dispersible resin is preferably composed of resin particles that can be dispersed in an aqueous solvent. The water-dispersible resin exhibits dispersibility in water, can be dispersed in water without being dissolved in water, and can form an oil-in-water (O/W) type emulsion.

The water-dispersible resin is preferably contained in the aqueous ink in a dispersed state as resin particles. The water-dispersible resin can be blended as a resin emulsion when the aqueous ink is produced.

Examples of the water-dispersible resin include conjugated diene-based resins such as styrene-butadiene copolymers, methyl methacrylate-butadiene copolymers, and vinyl chloride-vinyl acetate copolymers; (meth)acrylic-based resins such as acrylate ester polymers and methacrylate ester polymers, and copolymers of these compounds with styrene or the like; vinyl-based resins such as ethylene-vinyl acetate copolymers; functional group-modified resins in which a carboxyl group or the like of any of these resins has been modified with a functional group-containing monomer; as well as melamine resins, urea resins, polyurethane resins, polyester resins, polyolefin resins, silicone resins, polyvinyl butyral resins, and alkyd resins. Aqueous resin emulsions of any of these resin may be used. Resin emulsions containing one of these resins may be used, and hybrid resin emulsions may also be used. The term (meth)acrylic means methacrylic, acrylic, or both.

A single water-dispersible resin may be used, or a combination of two or more water-dispersible resins may be used. The amount of water-dispersible resin in the ink is preferably in a range from 0.5 to 30% by mass, and more preferably in a range from 1 to 20% by mass.

It is preferable to blend a water-soluble organic solvent in the ink. Organic compounds that are liquid at room temperature and can be dissolved in water can be used as the water-soluble organic solvent, and the use of a water-soluble organic solvent that mixes uniformly with an equal volume of water at 1 atmosphere and 20° C. is preferred. Examples of water-soluble organic solvents that may be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, 1-methyl-2-pyrrolidone, 1,3-dimethyl-2-imidazolidinone, β-thiodiglycol, and sulfolane. The boiling point of the water-soluble organic solvent is preferably 100° C. or higher, and more preferably 150° C. or higher.

One of these water-soluble organic solvents may be used alone, or a combination of two or more water-soluble organic solvents may be used, provided that the solvents form a single phase with water. The amount of water-soluble organic solvent in the ink (if two or more water-soluble organic solvents are used, the total amount thereof) is preferably in a range from 5 to 50% by mass, and more preferably in a range from 10 to 35% by mass.

The aqueous ink preferably contains a surfactant. Examples of surfactants that may be preferably used include anionic surfactants, cationic surfactants, amphoteric surfactants, and nonionic surfactants. One type of surfactant or a combination of two or more types thereof may be used. Among these, nonionic surfactants are particularly preferred. Further, the surfactant may be a low-molecular weight surfactant or a polymer-based surfactant.

Examples of nonionic surfactants include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether ester-based surfactants such as polyoxyethylene sorbitan fatty acid esters; acetylene-based surfactants; silicone-based surfactants; and fluorine-based surfactants. Among these, acetylene-based surfactants and silicone-based surfactants can be used particularly favorably.

Examples of acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group in the center, and may include a structure in which ethylene oxide has been added to acetylene glycol.

Examples of commercially available products of acetylene-based surfactants include the SURFYNOL series of products such as “SURFYNOL 104E”, “SURFYNOL 104H”, “SURFYNOL 420”, “SURFYNOL 440”, “SURFYNOL 465”, and “SURFYNOL 485” manufactured by Evonik Industries AG, and the OLFINE series of products such as “OLFINE E1004”, “OLFINE E1010”, and “OLFINE E1020” manufactured by Nissin Chemical Industry Co., Ltd. (wherein all of the above are product names).

Examples of silicone-based surfactants include polyether-modified silicone-based surfactants, alkyl-aralkyl-comodified silicone-based surfactants, and acrylic silicone-based surfactants.

Examples of commercially available products of silicone-based surfactants include “SILFACE SAG002”, “SILFACE SAG503A”, and “SILFACE SAG008” manufactured by Nissin Chemical Industry Co., Ltd. (wherein all of the above are product names).

Further examples of other nonionic surfactants include polyoxyethylene alkyl ether-based surfactants such as the EMULGEN series of products including “EMULGEN 102 KG, “EMULGEN 103”, “EMULGEN 104P”, “EMULGEN 105”, “EMULGEN 106”, “EMULGEN 108”, “EMULGEN 120”, “EMULGEN 147”, “EMULGEN 150”, “EMULGEN 220”, “EMULGEN 350”, “EMULGEN 404”, “EMULGEN 420”, “EMULGEN 705”, “EMULGEN 707”, “EMULGEN 709”, “EMULGEN 1108”, “EMULGEN 4085”, and “EMULGEN 2025G” manufactured by Kao Corporation (wherein all of the above are product names).

Examples of anionic surfactants include the EMAL series of products such as “EMAL 0”, “EMAL 10”, “EMAL 2F”, “EMAL 40”, and “EMAL 20C”, the NEOPELEX series of products such as “NEOPELEX GS”, “NEOPELEX G-15”, “NEOPELEX G-25”, and “NEOPELEX G-65”, the PELEX series of products such as “PELEX OT-P”, “PELEX TR”, “PELEX CS”, “PELEX TA”, “PELEX SS-L”, and “PELEX SS-H”, and the DEMOL series of products such as “DEMOL N”, “DEMOL NL”, “DEMOL RN”, and “DEMOL MS”, all manufactured by Kao Corporation (wherein all of the above are product names).

Examples of cationic surfactants include the ACETAMIN series of products such as “ACETAMIN 24” and “ACETAMIN 86”, the QUARTAMIN series of products such as “QUARTAMIN 24P”, “QUARTAMIN 86P”, “QUARTAMIN 60W”, and “QUARTAMIN 86W”, and the SANISOL series of products such as “SANISOL C” and “SANISOL B-50”, all manufactured by Kao Corporation (wherein all of the above are product names).

Examples of amphoteric surfactants include the AMPHITOL series of products such as “AMPHITOL 20BS”, “AMPHITOL 24B”, “AMPHITOL 86B”, “AMPHITOL 20YB”, and “AMPHITOL 20N” manufactured by Kao Corporation (wherein all of the above are product names).

One of the above surfactants may be used alone, and a combination of two or more surfactants may also be used.

An HLB value of the surfactant used for the aqueous ink is preferably 10.0 or less.

The surfactant used for the aqueous ink is preferably an acetylene-based surfactant, such as an acetylene glycol-based surfactant, and is more preferably an acetylene glycol-based surfactant.

The blend amount of surfactant in the aqueous ink, relative to the total amount of aqueous ink, is preferably in a range from 0.1 to 5.0% by mass and more preferably in a range from 0.5 to 3.0% by mass.

The aqueous ink may contain other components, if necessary. Examples of other components include pH adjusters and preservatives.

The viscosity of the aqueous ink is, at 23° C., preferably in a range from 1 to 20 mPa·s, more preferably in a range from 2 to 15 mPa·s, and even more preferably in a range from 3 to 10 mPa·s.

The method for producing an aqueous ink is not particularly limited. A desired ink can be obtained by mixing together components in an appropriate manner. The obtained composition may be filtered using a filter or the like, for example. Any of various additives may be added as appropriate. With respect to the titanium oxide composite particles, the aqueous dispersion containing titanium oxide composite particles produced by the above method for producing an aqueous dispersion may be used. The method for producing an ink may include a step of producing the aqueous dispersion containing the titanium oxide composite particles produced by the above method for producing an aqueous dispersion, for example.

In the present embodiment, a recording medium is not particularly limited, and examples of recording media that can be used include printing papers such as plain papers, coated papers, and specialty papers, fabrics, inorganic sheets, films, OHP sheets, and adhesive sheets having one of the above media as base material and having an adhesive layer provided on the rear surface.

The present disclosure includes the following embodiments. The present invention is not limited to the embodiments described below.

<1>

A method for producing an aqueous dispersion, the method including:
step 1 of obtaining an aqueous titanium oxide dispersion containing titanium oxide particles, a dispersant, and water; and
step 2 of obtaining a titanium oxide composite particle by adding a polymerizable monomer and a polymerization initiator to the aqueous titanium oxide dispersion to polymerize the polymerizable monomer, in which
step 2 includes a step of adding the polymerizable monomer at a mass ratio of 1/5 or more relative to the total amount of the titanium oxide particles at one time, and
the polymerizable monomer contains a polymerizable monomer A of which solubility in water is 0.5 g/100 ml or less at 23° C.
   <2>

The method for producing an aqueous dispersion according to <1>, in which
the titanium oxide composite particles are raspberry-like composite particles containing the titanium oxide particles and a resin covering surfaces of the titanium oxide particles.
   <3>

The method for producing an aqueous dispersion according to <2>, in which
the resin has a shape of a resin particles.
   <4>

The method for producing an aqueous dispersion according to any one of <1> to <3>, in which
the amount of the polymerizable monomer A relative to the total amount of the polymerizable monomer is 30% by mass or more.
   <5>

The method for producing an aqueous dispersion according to any one of <1> to <4>, in which
the titanium oxide particles contain titanium oxide particles of which surfaces are treated with at least alumina.
   <6>

The method for producing an aqueous dispersion according to any one of <1> to <5>, in which
the dispersant contains a dispersant having an acidic group.

<7>

The method for producing an aqueous dispersion according to any one of <1> to <6>, in which
the polymerization initiator contains a polymerization initiator having a zwitterionic structure.
   <8>

An aqueous dispersion including:
raspberry-like titanium oxide composite particles containing titanium oxide particles and a resin covering surfaces of the titanium oxide particles; and
water.
   <9>

An aqueous ink including:
raspberry-like titanium oxide composite particles containing titanium oxide particles and a resin covering surfaces of the titanium oxide particles; and
water.

### Examples

The present invention will be described below in further detail using examples. The present invention is not limited to the examples below.

In Tables 1 to 3, “Ex” represents “Example”, “CEx” represents “Comparative Example”, “AD” represents “aqueous dispersion”, and “WI” represents “white ink”.

### (1) Production of Aqueous Titanium Oxide Dispersions 1 and 2

In a glass container with a capacity of 250 mL, 30 g of purified water, 20 g of titanium oxide powder 1, and 0.25% by mass of a sodium salt (NaOH neutralization degree=0.7, polymeric dispersant having an acidic group) of “ISOBAN-600” (manufactured by Kuraray Co., Ltd., isobutylene-maleic acid copolymer) relative to the titanium oxide powder 1 were added and stirred. Thereafter, 135 g of zirconia beads with a diameter of 0.5 mm were added thereto, and a treatment was performed at a rotation speed of 100 rpm for four hours using a pot mill rotor, the beads were separated out, and accordingly the aqueous titanium oxide dispersion 1 was obtained. The aqueous titanium oxide dispersion 2 was obtained in the same manner as the production of the aqueous titanium oxide dispersion 1, except that 20 g of titanium oxide powder 2 below was used instead of 20 g of the titanium oxide powder 1. The average particle diameter (dispersion particle diameter) of titanium oxide particles in each of the obtained aqueous titanium oxide dispersions 1 and 2 was measured using a dynamic light scattering method (DLS). The average particle diameter of the aqueous titanium oxide dispersion 1 was 340 nm and the average particle diameter of the aqueous titanium oxide dispersion 2 was 330 nm. The average particle diameter (dispersion particle diameter) of each of the aqueous titanium oxide dispersions 1 and 2 and aqueous dispersions 1-R to 8-R, described later, was measured by means of DLS using “ELSZ-200ZS” manufactured by Otsuka Electronics Co., Ltd.
Titanium oxide powder 1: “JR-605” manufactured by TAYCA CORPORATION (titanium oxide particles subjected to surface treatment with alumina, primary particle diameter: 250 nm)
Titanium oxide powder 2: “CR-90” manufactured by ISHIHARA SANGYO KAISHA, LTD. (titanium oxide particles subjected to surface treatment with silica and alumina, primary particle diameter: 250 nm)

### (2) Production of Aqueous Dispersions 1-R to 9-R

Table 1 shows materials used for production of the aqueous dispersions 1-R to 9-R and the amounts used thereof.

### (2-1) Production of Aqueous Dispersions 1-R to 4-R and 7-R

### (i) First Stage

Purified water was added to the aqueous titanium oxide dispersion 1 or 2 obtained above to prepare a dispersion liquid containing, in 280 g of water, 10.0 g of titanium oxide and 0.25% by mass of a sodium salt (NaOH neutralization degree=0.7) of “ISOBAN-600” relative to the titanium oxide. The dispersion liquid was placed in a 500 mL four-necked flask equipped with a stirrer, a thermometer, a dropping funnel, and a reflux cooler and stirred for 10 minutes. Thereafter, 1.0 g of an aqueous solution obtained by dissolving 0.025 g of sodium dodecyl sulfate in 1.0 g of purified water was added. Next, the temperature was raised to 70° C., 1.0 g of an aqueous solution containing 0.10 g of “VA-057” (manufactured by FUJIFILM Wako Pure Chemical Corporation, 2,2-azobis(2-amidinopropane) dihydrochloride, a polymerization initiator having a zwitterionic structure) was added. Further, 1.0 g of a polymerizable monomer shown in Table 1 was added, and the mixture was left for 60 minutes.

### (ii) Second Stage

Next, 3.0 g of an aqueous solution containing 0.4 g of sodium dodecyl sulfate and 1.0 g of an aqueous solution containing 0.10 g of “VA-057” were further added, and 9.0 g of a polymerizable monomer shown in Table 1 was added, the mixture was held at 70° C. for four hours, and stirring was continued. After cooling, filtration with a 100 μm mesh was performed, and the aqueous dispersions 1 to 4 and 7 were obtained. The obtained aqueous dispersions 1 to 4 and 7 were centrifuged at 4000 rpm for 15 minutes, the supernatant was separated, thereafter purified water was added such that the amount of titanium oxide was 25% by mass and the mixture was stirred, and thus the aqueous dispersions 1-R to 4-R and 7-R were obtained. The average particle diameter (dispersion particle diameter) of titanium oxide composite particles of each of the obtained aqueous dispersions 1-R to 4-R, and 7-R was measured using a dynamic light scattering method (DLS). Further, a small amount of aqueous dispersions 1-R to 4-R and 7-R was lyophilized, and the particle shape of the lyophilized powder was observed using an electron scanning microscope (SEM). A JSM-7600FA manufactured by JEOL LTD. was used as the SEM.

### (2-2) Production of Aqueous Dispersion 5-R

### (i) First Stage

Purified water was added to the aqueous titanium oxide dispersion 1 obtained above to prepare a dispersion liquid containing, in 280 g of water, 10.0 g of titanium oxide and 0.25% by mass of a sodium salt (NaOH neutralization degree=0.7) of “ISOBAN-600” relative to the titanium oxide, the dispersion liquid was placed in a 500 mL four-necked flask equipped with an stirrer, a thermometer, a dropping funnel, and a reflux cooler, and the mixture was stirred at room temperature under a nitrogen atmosphere. An aqueous solution obtained by dissolving 1.8 mg of “ADEKA REASOAP NE-10” manufactured by ADEKA CORPORATION in 1.0 g of purified water was added over about 1 minute, and the mixture was stirred for ten minutes.

Thereafter, the temperature was raised to 55° C., the mixture was further stirred for 10 minutes, and thereafter 1.0 g of an aqueous solution obtained by dissolving 0.025 g of sodium dodecyl sulfate in 1.0 g of purified water was added. Next, the temperature was raised to 70° C., 1.0 g of an aqueous solution containing 0.10 g of “VA-057” was added, 1.0 g of a polymerizable monomer shown in Table 1 was added, and the mixture was left for 60 minutes.

### (ii) Second Stage

Next, 3.0 g of an aqueous solution containing 0.4 g of sodium dodecyl sulfate and 1.0 g of an aqueous solution containing 0.10 g of “VA-057” were further added, 9.0 g of a polymerizable monomer shown in Table 1 was added, the mixture was held at 70° C. for four hours, and stirring was continued. After cooling, filtration with a 100 μm mesh was performed and the aqueous dispersion 5 was obtained. The obtained aqueous dispersion 5 was centrifuged at 4000 rpm for 15 minutes, the supernatant was separated, thereafter purified water was added such that the amount of titanium oxide was 25% by mass, and the mixture was stirred, and thus the aqueous dispersion 5-R was obtained. The average particle diameter (dispersion particle diameter) of titanium oxide composite particles of the obtained aqueous dispersion 5-R was measured using a DLS. Further, a small amount of aqueous dispersion 5-R was lyophilized, and the particle shape of the lyophilized powder was observed using an SEM.

### (2-3) Production of Aqueous Dispersion 6-R

The aqueous dispersion 6 was produced in the same manner as the production of the aqueous dispersion 1, except that “KPS” (manufactured by FUJIFILM Wako Pure Chemical Corporation, potassium persulfate, anionic polymerization initiator) was used instead of “VA-057” as a polymerization initiator. The obtained aqueous dispersion 6 was centrifuged at 4000 rpm for 15 minutes, the supernatant was separated, thereafter water was added such that the amount of titanium oxide was 25% by mass, and the mixture was stirred, and thus the aqueous dispersion 6-R was obtained. The average particle diameter (dispersion particle diameter) of titanium oxide composite particles of the obtained aqueous dispersion 6-R was measured using a DLS. Further, a small amount of aqueous dispersion 6-R was lyophilized, and the particle shape of the lyophilized powder was observed using an SEM.

### (2-4) Production of Aqueous Dispersion 8-R

The aqueous dispersion 8 was produced in the same manner as the production of the aqueous dispersion 1, except that “V-501” (manufactured by FUJIFILM Wako Pure Chemical Corporation, 4,4′-azobis(4-cyanovaleric acid)) was used instead of “VA-057” as a polymerization initiator, sodium dodecyl sulfate of a surfactant was not used, and a polymerizable monomer was continuously added dropwise at a rate of 1.25 mL/L instead of adding the polymerizable monomer at one time in each of two separate stages—a first stage and a second stage—. The obtained aqueous dispersion 8 was centrifuged at 4000 rpm for 15 minutes, the supernatant was separated, thereafter water was added such that the amount of titanium oxide was 25% by mass and the mixture was stirred, and thus the aqueous dispersion 8-R was obtained. The average particle diameter (dispersion particle diameter) of titanium oxide composite particles of the obtained aqueous dispersion 8-R was measured using a DLS. Further, a small amount of aqueous dispersion 8-R was lyophilized, and the particle shape of the lyophilized powder was observed using an SEM.

### (2-5) Production of Aqueous Dispersion 9-R

The aqueous dispersion 9 was produced by adding 275.6 g of purified water to 25.0 g of aqueous titanium oxide dispersion 1. The obtained aqueous dispersion 9 was centrifuged at 4000 rpm for 15 minutes, the supernatant was separated, thereafter purified water was added such that the amount of titanium oxide was 25% by mass and the mixture was stirred, and thus the aqueous dispersion 9-R was obtained.

Details of the sodium dodecyl sulfate and polymerizable monomer used above are as follows.
Sodium dodecyl sulfate: manufactured by FUJIFILM Wako Pure Chemical Corporation
Styrene: solubility in water is 0.03 g/100 ml at 23° C., manufactured by FUJIFILM Wako Pure Chemical Corporation
Benzyl methacrylate: solubility in water is 0.3 g/100 ml at 23° C., manufactured by FUJIFILM Wako Pure Chemical Corporation
n-butyl methacrylate: solubility in water is 0.3 g/100 ml at 23° C., manufactured by FUJIFILM Wako Pure Chemical Corporation
Methyl methacrylate: solubility in water is 1.59 g/100 ml at 23° C., manufactured by FUJIFILM Wako Pure Chemical Corporation

TABLE 1
Formulation and measurement/observation results of aqueous dispersion

| | | Ex 1 | Ex 2 | Ex 3 | Ex 4 | Ex 5 | Ex 6 | CEx 1 | CEx 2 | CEx 3 |
|---|---|---|---|---|---|---|---|---|---|---|
| | | AD 1 | AD 2 | AD 3 | AD 4 | AD 5 | AD 6 | AD 7 | AD 8 | AD 9 |
| Aqueous | Aqueous | 25.0 | | 25.0 | 25.0 | 25.0 | 25.0 | 25.0 | 25.0 | 25.0 |
| titanium | titanium oxide | | | | | | | | | |
| oxide | dispersion 1 | | | | | | | | | |
| disper- | Aqueous | | 25.0 | | | | | | | |
| sion | titanium oxide | | | | | | | | | |
| | dispersion 2 | | | | | | | | | |
| Surfac- | Sodium | 0.4 | 0.4 | 0.4 | 0.4 | 0.4 | 0.4 | 0.4 | | |
| tant | dodecyl sulfate | | | | | | | | | |
| | “ADEKA | | | | | 0.02 | | | | |
| | REASOAP | | | | | | | | | |
| | NE-10” | | | | | | | | | |
| Polymer- | “VA-057” | 0.2 | 0.2 | 0.2 | 0.2 | 0.2 | | 0.2 | | |
| ization | “KPS” | | | | | | 0.2 | | | |
| initiator | “V-501” | | | | | | | | 0.2 | |
| Polymer- | Styrene | 10.0 | 10.0 | | 7.0 | 10.0 | 10.0 | | 10.0 | |
| izable | Benzyl | | | 10.0 | | | | | | |
| mono- | methacrylate | | | | | | | | | |
| mer | n-butyl | | | | 3.0 | | | | | |
| | methacrylate | | | | | | | | | |
| | Methyl | | | | | | | 10.0 | | |
| | methacrylate | | | | | | | | | |

| Purified water | 265.0 | 265.0 | 265.0 | 265.0 | 265.0 | 265.0 | 265.0 | 265.0 | 275.6 |
|---|---|---|---|---|---|---|---|---|---|
| Total (unit: g) | 300.6 | 300.6 | 300.6 | 300.6 | 300.8 | 300.6 | 300.6 | 300.2 | 300.6 |
| Method for adding | X | X | X | X | X | X | X | Y | — |
| polymerizable monomer | | | | | | | | | |
| | AD | AD | AD | AD | AD | AD | AD | AD | AD |
| | 1-R | 2-R | 3-R | 4-R | 5-R | 6-R | 7-R | 8-R | 9-R |
| Average particle diameter | 500 | 480 | 460 | 460 | 500 | 460 | 410 | 420 | 340 |
| (dispersion particle | | | | | | | | | |
| diameter) of titanium oxide | | | | | | | | | |
| composite particles (unit: | | | | | | | | | |
| nm) | | | | | | | | | |
| Shape of titanium oxide | R | R | R | R | R | R | NR | NR | — |
| composite particles | | | | | | | | | |

X: adding 1.0 g of polymerizable monomer at one time in first stage, and adding 9.0 g of polymerizable monomer at one time in second stage
Y: Adding continuously
R: Raspberry shape
NR: Non-raspberry shape

### (3) Production of Aqueous Ink

Materials were mixed according to the formulation shown in Table 2, the mixture was stirred thoroughly until it became uniform, thereafter the mixture were filtered using a membrane filter. White inks 1 to 9 were prepared as aqueous inks accordingly.

Details of the materials shown in Table 2 are as follows.
Aqueous dispersions 1-R to 9-R: produced above
Water-dispersible (meth)acrylic-based resin: manufactured by Japan Coating Resin Corporation, “Mowinyl 6820” ((meth)acrylic-based resin emulsion) (active ingredient: 50% by mass)
Glycerin: manufactured by Tokyo Chemical Industry Co., Ltd.
“OLFINE E1010”: manufactured by Nissin Chemical Industry Co., Ltd., acetylene-based surfactant

TABLE 2
Formulation of aqueous ink

| | | Ex 1 | Ex 2 | Ex 3 | Ex 4 | Ex 5 | Ex 6 | CEx 1 | CEx 2 | CEx 3 |
|---|---|---|---|---|---|---|---|---|---|---|
| | | WI 1 | WI 2 | WI 3 | WI 4 | WI 5 | WI 6 | WI 7 | WI 8 | WI 9 |
| AD | AD 1-R | 20.0 | | | | | | | | |
| | AD 2-R | | 20.0 | | | | | | | |
| | AD 3-R | | | 20.0 | | | | | | |
| | AD 4-R | | | | 20.0 | | | | | |
| | AD 5-R | | | | | 20.0 | | | | |
| | AD 6-R | | | | | | 20.0 | | | |
| | AD 7-R | | | | | | | 20.0 | | |
| | AD 8-R | | | | | | | | 20.0 | |
| | AD 9-R | | | | | | | | | 20.0 |
| Water- | Water- | 30.0 | 30.0 | 30.0 | 30.0 | 30.0 | 30.0 | 30.0 | 30.0 | 30.0 |
| disper- | dispersible | | | | | | | | | |
| sible | (meth)acrylic- | | | | | | | | | |
| resin | based resin | | | | | | | | | |
| Water- | Glycerin | 10.0 | 10.0 | 10.0 | 10.0 | 10.0 | 10.0 | 10.0 | 10.0 | 10.0 |
| soluble | | | | | | | | | | |
| organic | | | | | | | | | | |
| solvent | | | | | | | | | | |
| Surfac- | OLFINE | 0.7 | 0.7 | 0.7 | 0.7 | 0.7 | 0.7 | 0.7 | 0.7 | 0.7 |
| tant | E1010 | | | | | | | | | |

| | | | | | | | | | |
|---|---|---|---|---|---|---|---|---|---|
| Purified water | 39.3 | 39.3 | 39.3 | 39.3 | 39.3 | 39.3 | 39.3 | 39.3 | 39.3 |
| Total | 100.0 | 100.0 | 100.0 | 100.0 | 100.0 | 100.0 | 100.0 | 100.0 | 100.0 |
| (unit: % by mass) | | | | | | | | | |

### (4) Evaluation

The following evaluation was performed using the aqueous dispersions 1-R to 9-R and white inks 1 to 9.

### <Dispersion Stability>

The viscosity of each of the aqueous dispersions 1-R to 9-R was measured and used as an initial value. Each of the aqueous dispersions 1-R to 9-R was then placed in a well-closed container. After one month of storage in a thermostatic chamber at 50° C., the viscosity was measured, and an evaluation was made using the following criteria. The viscosity of each of the aqueous dispersions 1-R to 9-R was the viscosity at 23° C. and measured with a rheometer MCR102 (manufactured by Anton Paar GmbH).

### Evaluation Criteria

A: Viscosity change ratio from initial value is less than 5%
B: Viscosity change ratio from initial value is 5% or more and less than 10%
C: Viscosity change ratio from initial value is 10% or more

### <Redispersibility>

Each of the aqueous dispersions 1-R to 9-R was placed in a well-closed container, and the container was placed in a stationary position at room temperature for seven days. Each of the aqueous dispersions 1-R to 9-R was then stirred for ten minutes with a mix rotor, and was visually observed whether precipitated particles were redispersed.

### (Evaluation Criteria)

S: All particles are redispersed
A: Most particles are redispersed, but some precipitates remain
B: Particles are not easily redispersed, and many precipitates remain
C: No change in precipitate

### <Whiteness>

Each of the white inks 1 to 9 was coated on a transparent PET film using a 10 μm bar coater, and a dried printed matter was prepared. The whiteness of the printed matter was evaluated using an L* value. Specifically, the printed matter was placed on a uniform density plate, and the L* value was measured using a colorimeter (“X-Rite eXact” manufactured by Videojet X-Rite K.K.) to determine the whiteness.

### (Evaluation Criteria)

A: L* value: 70 or more
B: L* value: 65 or more and less than 70
C: L* value: less than 65

TABLE 3
Evaluation results

| | Ex 1 | Ex 2 | Ex 3 | Ex 4 | Ex 5 | Ex 6 | CEx 1 | CEx 2 | CEx 3 |
|---|---|---|---|---|---|---|---|---|---|
| | AD | AD | AD | AD | AD | AD | AD | AD | AD |
| | 1-R | 2-R | 3-R | 4-R | 5-R | 6-R | 7-R | 8-R | 9-R |
| | WI 1 | WI 2 | WI 3 | WI 4 | WI 5 | WI 6 | WI 7 | WI 8 | WI 9 |
| Dispersion | A | A | A | A | A | A | B | B | C |
| stability | | | | | | | | | |
| Redispersibility | S | S | S | A | S | A | B | B | C |
| Whiteness | A | A | A | A | A | A | C | B | C |

As shown in Table 1, raspberry-like titanium oxide composite particles were formed in the aqueous dispersions 1-R to 6-R. As shown in Table 3, the white inks 1 to 6 of Examples 1 to 6 using the aqueous dispersions 1-R to 6-R have excellent whiteness. Further, the aqueous dispersions 1-R to 6-R of Examples 1 to 6 also have excellent dispersion stability and redispersibility.

In the aqueous dispersion 7 (Comparative Example 1), the polymerizable monomer A of which solubility in water is 0.5 g/100 ml or less at 23° C. is not used, and in the aqueous dispersion 8 (Comparative Example 2), a polymerizable monomer was continuously added without including the step of adding a polymerizable monomer at a mass ratio of 1/5 or more relative to the total amount of titanium oxide particles at one time. In the aqueous dispersion 7 and the aqueous dispersion 8, the obtained titanium oxide composite particles have a non-raspberry shape. The white inks 7 and 8 of Comparative Examples 1 and 2, in which the aqueous dispersions 7-R and 8-R were used, were inferior in whiteness. Further, the aqueous dispersions 7-R and 8-R of Comparative Examples 1 and 2 were inferior in both dispersion stability and redispersibility.

The white ink 9 of Comparative Example 3, in which the aqueous dispersion 9-R, which is an aqueous titanium oxide dispersion dispersed with a dispersant, was used, was inferior in whiteness. Still further, the aqueous dispersion 9-R of Comparative Example 3 was inferior in both dispersion stability and redispersibility.

It is to be noted that, besides those already mentioned above, many modifications and variations of the above embodiments may be made without departing from the novel and advantageous features of the present invention. Accordingly, all such modifications and variations are intended to be included within the scope of the appended claims.

1. A method for producing an aqueous dispersion, the method comprising:
obtaining an aqueous titanium oxide dispersion containing titanium oxide particles, a dispersant, and water; and
obtaining titanium oxide composite particles by adding a polymerizable monomer and a polymerization initiator to the aqueous titanium oxide dispersion to polymerize the polymerizable monomer, wherein
the obtaining of the titanium oxide composite particles includes adding the polymerizable monomer at a mass ratio of 1/5 or more relative to a total amount of the titanium oxide particles at one time, and
the polymerizable monomer contains a polymerizable monomer A of which solubility in water is 0.5 g/100 ml or less at 23° C.

2. The method for producing an aqueous dispersion according to claim 1, wherein
the titanium oxide composite particles are raspberry-like composite particles containing the titanium oxide particles and a resin covering surfaces of the titanium oxide particles.

3. The method for producing an aqueous dispersion according to claim 2, wherein
the resin has a shape of resin particles.

4. The method for producing an aqueous dispersion according to claim 1, wherein
the amount of the polymerizable monomer A relative to a total amount of the polymerizable monomer is 30% by mass or more.

5. The method for producing an aqueous dispersion according to claim 1, wherein
the titanium oxide particles contain titanium oxide particles of which surfaces are treated with at least alumina.

6. The method for producing an aqueous dispersion according to claim 1, wherein
the dispersant contains a dispersant having an acidic group.

7. The method for producing an aqueous dispersion according to claim 1, wherein
the polymerization initiator contains a polymerization initiator having a zwitterionic structure.

8. An aqueous dispersion comprising:
raspberry-like titanium oxide composite particles containing titanium oxide particles and a resin covering surfaces of the titanium oxide particles; and
water.

9. The aqueous dispersion according to claim 8, wherein
the resin has a shape of resin particles.

10. An aqueous ink comprising:
raspberry-like titanium oxide composite particles containing titanium oxide particles and a resin covering surfaces of the titanium oxide particles; and
water.

11. The aqueous ink according to claim 10, wherein
the resin has a shape of resin particles.
